(19) United States
(12) Patent Application Publication
(10) Pub. No.: US 2012/0130792 A1
(43) Pub. Date: May 24, 2012

(54) SYSTEM AND METHOD OF REDEEMING COUPONS AND PREVENTING WEB-BASED COUPON FRAUD

(76) Inventors: James W. Polk, JR., Georgetown, IN (US); Michael L. Hasty, Louisville, KY (US); Daniel Wilson Maddox, Palmyra, IN (US); Marcellinus Petrus van der Veer, Louisville, KY (US); Mark Willis, Louisville, KY (US)

(21) Appl. No.: 13/152,909

(22) Filed: Jun. 3, 2011

Related U.S. Application Data
(60) Provisional application No. 61/416,582, filed on Nov. 23, 2010.

(51) Int. Cl. G06Q 30/00

(52) U.S. Cl. 705/14.26

(57) ABSTRACT

A web-based system and method are provided for electronic coupon fraud prevention. The system receives electronic coupon parameters from a coupon provider via a host website. Access is selectively providing to electronic coupons by members based on the parameters and member access criteria. The member selects coupons via the website which are then stored in a member account. Transaction data is received from a merchant point of sale, and the system determines which coupons may be available for use in the transaction based on the coupon parameters and the transaction data. A first set of coupon data is provided to the point of sale associated with electronic coupons which have been determined to be available, and a second set of electronic coupon data is received from the point of sale associated with electronic coupons which have been redeemed by the merchant in association with the financial transaction.

### CROSS-REFERENCES TO RELATED APPLICATIONS

This application claims benefit of the following patent application(s) which is/are hereby incorporated by reference: U.S. Provisional Patent Application No. 61/416,582, filed Nov. 23, 2010.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### BACKGROUND OF THE INVENTION

The present invention relates generally to financial transactions using electronic coupons. More particularly, the present invention relates to a host system, web-accessible user interface and associated method for preventing the fraudulent use of electronic coupons in point-of-sale financial transactions.

The coupon industry began as a way for manufacturers of consumer products (CPG's) to provide incentives for consumers to purchase their products from stores associated with all or a select group of merchants. These offers have been delivered for example in the stores themselves, through direct mail or in newspapers. When redeemed, the merchants would key in or scan a coupon, provide the discount to the consumer, and complete a lengthy and costly reconciliation process to be reimbursed by the CPG for the discount given to the consumer plus an administrative fee.

While consumers were aware of the offers, many times they might forget to clip the coupons, or simply had no interest in looking through all of the offers that they have received for any that they might be interested in using. The advent of the Internet and coupon “clipping” sites dramatically changed the coupon industry. Pioneers in this industry identified and addressed problems in the coupon industry by providing an aggregation point for CPG's to place their coupons, and for consumers to frequent to find offers that were of value to them. The companies spent decreasing amounts on printed coupons to be sent to the consumer, and increased amounts on digital delivery.

Consumers in such digital delivery systems as are conventionally known generally select and print the coupons that they desire. To the redeeming merchant, the coupons looked identical, and were then keyed in or a barcode was scanned directly from the printed coupon. The CPG's reimbursed the merchants for the value plus an additional processing fee. This process both improved the marketing effectiveness of the CPG's, and the real and perceived value to the consumer.

However, the approach created new problems, and left old ones substantially unresolved. Fraud has been rampant, at least in part due to the digital nature of the process, and prompting some merchants to disallow use of Internet coupons in their stores. Usage still depends on the consumer to print and bring the coupons to the merchant. Application is still dependent on the consumer to remember the coupons they have, and the products that they purchased. Reconciliation of the value given by the merchant to the consumer is still reliant on a manual paper collection process from and across merchants to each CPG.

There is known in the art an electronic coupon process which involves loading coupons to one or more retailer loyalty cards, rather than physically printing the coupons, and presenting the loyalty card at a point-of-sale. However, each time a coupon is used with regards to a particular merchant, it may be necessary to electronically communicate with each other merchant and cancel the coupon or check to ensure that the coupon remains valid based on parameters or rules set by that particular merchant. Where the parameters or rules set by individual merchants are distinct from other merchants or from the coupon provider, the system may further become overly complex.

### BRIEF SUMMARY OF THE INVENTION

Systems and methods are disclosed herein for preventing fraudulent use of electronic coupons.

In an embodiment, a web-based host system includes a website and associated user interface. The system receives electronic coupon parameters associated with one or more electronic coupons from a coupon provider via the website. Transaction data associated with a financial transaction is received from a point of sale associated with a merchant. Availability of one or more electronic coupons for use in the transaction is determined based on the coupon parameters and the transaction data. A first set of electronic coupon data associated with one or more electronic coupons which have been determined to be available is transmitted from the host system to the point of sale. A second set of electronic coupon data associated with one or more electronic coupons which have been redeemed by the merchant in association with the financial transaction is received from the point of sale, and the host system automatically reconciles accounts for the coupon provider and the merchant.

In another embodiment, one or more computer-readable memory media are embodied with instructions executable by a processor to cause the processor to perform operations including receiving electronic coupon parameters from a coupon provider via a host website, selectively providing access to electronic coupons by a website user based on the electronic coupon parameters and access criteria associated with the user, storing electronic coupons selected by the user in a user account, receiving transaction data associated with a financial transaction from a merchant point of sale associated with a merchant, determining the availability of one or more electronic coupons for use in the transaction based on the coupon parameters and the transaction data, providing a first set of electronic coupon data to the point of sale associated with one or more electronic coupons which have been determined to be available, and receiving a second set of electronic coupon data from the point of sale associated with one or more electronic coupons which have been redeemed by the merchant in association with the financial transaction.

### BRIEF DESCRIPTION OF THE SEVERAL VIEWS OF THE DRAWINGS

FIG. 1 is a block diagram representing an embodiment of a host system in accordance with the present invention.

FIG. 2 is a flowchart representing an embodiment of an electronic coupon processing method in accordance with the present invention.

FIG. 3 is a flowchart representing another embodiment of an electronic coupon processing method in accordance with the present invention.

FIG. 4 is a flowchart representing various sub-steps of an electronic coupon validation step in an embodiment of a coupon processing method in accordance with the present invention.

### DETAILED DESCRIPTION OF THE INVENTION

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

Terms such as “providing,” “processing,” “supplying,” “determining,” “calculating” or the like may refer at least to an action of a computer system, computer program, signal processor, logic or alternative analog or digital electronic device that may be transformative of signals represented as physical quantities, whether automatically or manually initiated.

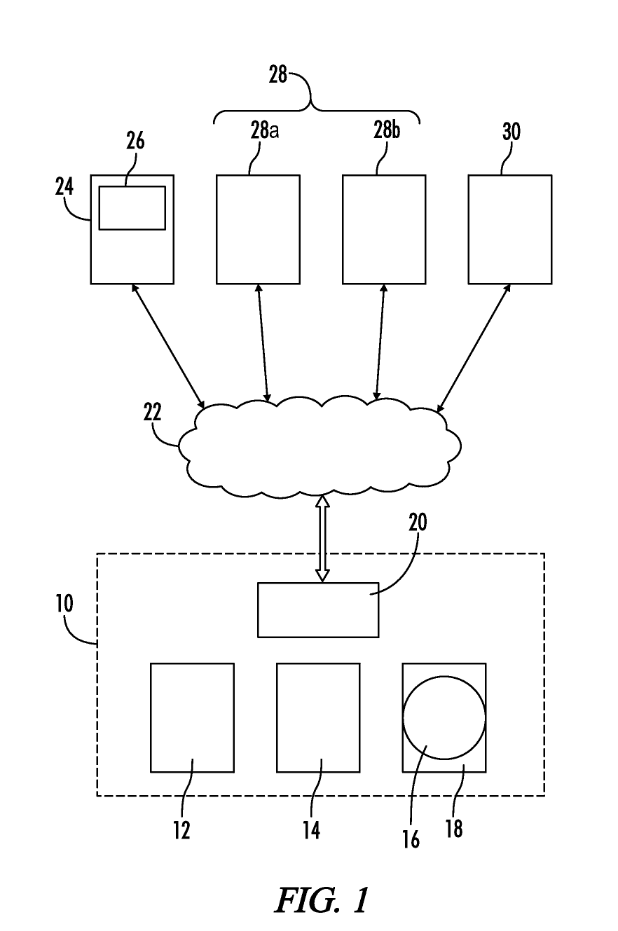

Referring generally to FIGS. 1 to 4, various embodiments may be described herein of a web-based host system and methods of processing electronic coupons for substantially preventing fraudulent use of the coupons. Where the various figures may describe embodiments sharing various common elements and features with other embodiments, similar elements and features are given the same reference numerals and redundant description thereof may be omitted below.

Referring first to FIG. 1, an embodiment of a host system 10 or administrator system 10 associated with a service provider or administrator of the present invention may generally be a computer-based system residing on a remote server which is effective to receive and transmit data over a communications network 22 with user systems 24 associated with users (i.e., members of the host system and/or visitors to a website associated with the host system), merchant systems 28 associated with one or more locations (i.e., points of sale or hereafter “POS”) of a merchant or with various separate merchants 28a, 28b, and with coupon provider systems 30 associated with for example manufacturers or distributors of consumer products. The “systems” associated with one or more of the users 24, merchants 28 and/or coupon providers 30 may unless otherwise stated include without limitation personal computers, mobile computing devices, mobile communications devices, or a plurality of systems including such devices.

A computer-readable memory medium 18 may be provided containing a computer program 16 executable by one or more data processors 12 using techniques as previously well known in the art. A single memory medium 18 may be provided which is effective to store the computer program 16 and also any data which is received and used in relation to the program 16, or a plurality of memory media 18 such as databases or equivalent storage entities may be provided and functionally linked to collectively perform the functions of the system 10 as described herein. A storage device 14 or database 14 may be provided for receiving and storing data relevant to methods of the present invention as further described below, and the database 14 so provided may in certain embodiments be one of the plurality of memory media 18 or may be physically separate but functionally linked to the other system components.

The term “computer-readable memory medium” as used herein may refer to any medium alone or as one of a plurality of memory media having processor-executable software, instructions or program modules which upon execution may provide data or otherwise cause a computer system to implement subject matter or otherwise operate in a specific manner as further defined herein. It may further be understood that more than one type of memory media may be used in combination to conduct processor-executable software, instructions or program modules from a first memory medium upon which the software, instructions or program modules initially reside to a processor for execution.

“Memory media” may further include without limitation transmission media and/or storage media. “Storage media” may refer in an equivalent manner to volatile and non-volatile, removable and non-removable media, including at least dynamic memory, application specific integrated circuits (ASIC), chip memory devices, optical or magnetic disk memory devices, flash memory devices, or any other medium which may be used to stored data in a processor-accessible manner, and may unless otherwise stated either reside on a single computing platform or be distributed across a plurality of such platforms. “Transmission media” may include any tangible media effective to permit processor-executable software, instructions or program modules residing on the media to be read and executed by a processor, including without limitation wire, cable, fiber-optic and wireless media such as is known in the art.

The term “processor” as used herein may refer to at least general-purpose or specific-purpose processing devices and/or logic as may be understood by one of skill in the art, including but not limited to central processors, parent processors, graphical processors, media processors, and the like.

The computer program 16 in various embodiments may contain various instructions executable from a single program to perform functions as described below. The program instructions may more particularly contain or otherwise define a plurality of software modules executable by the data processor 12 to perform functions as described below. In various embodiments the system 10 may include a plurality of servers upon which separate components reside but are electronically coupled, or upon which identical copies of the various components reside for more rapid and efficient use of resources.

In various embodiments the system 10 may include or otherwise be effective to generate a communications network interface 20 for facilitating the receipt from and transmittal of data to external systems 24, 28, 30 for example functionally linked to the interface 20 over a communications network 22. The term “communications network” as used herein with respect to data communication between two or more parties or otherwise between communications network interfaces associated with two or more parties may refer to any one of, or a combination of any two or more of, telecommunications networks (whether wired, wireless, cellular or the like), a global network such as the Internet, local networks, network links, Internet Service Providers (ISP's), and intermediate communication interfaces. The system 10 may generally include a website containing a graphical user interface by which users 24, merchants 28 and coupon providers 30 may access the system 10.

The system 10 may in certain embodiments further include instructions or data which may be downloaded and stored in for example a mobile computing or mobile communications device such that a graphical user interface 26 may be launched and displayed on the remote device (e.g., a user system 24), and whereby data may for example be transmitted and received between the remote device and various components of the host system 10 without for example the assistance of a web browser.

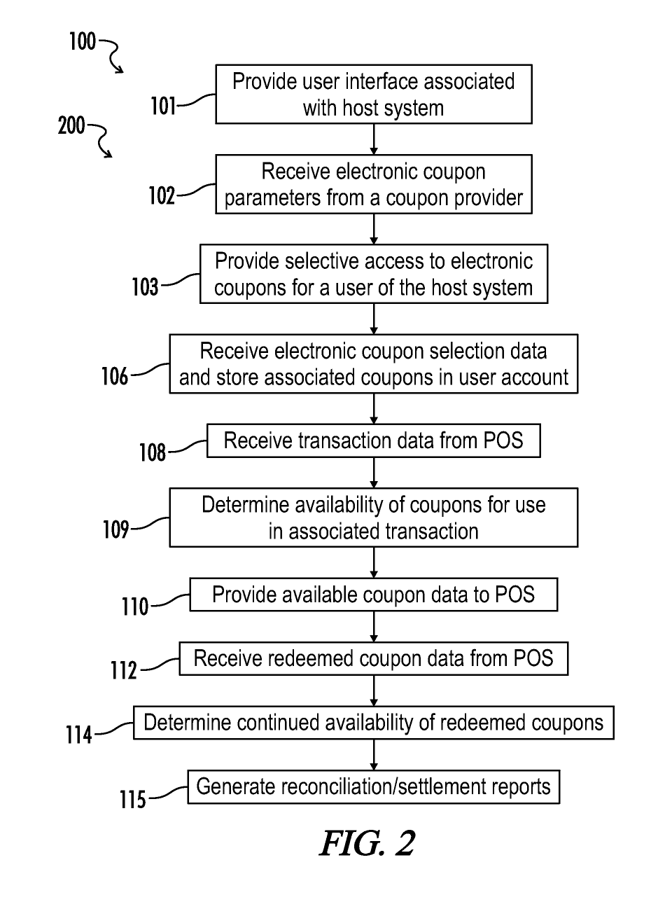

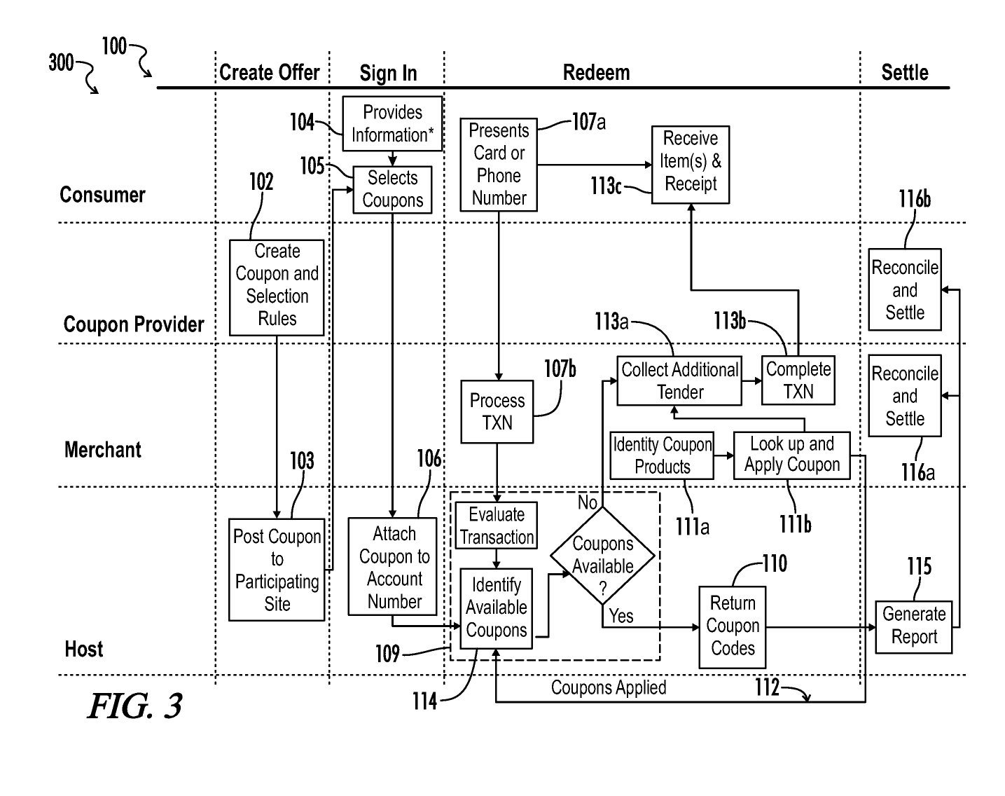

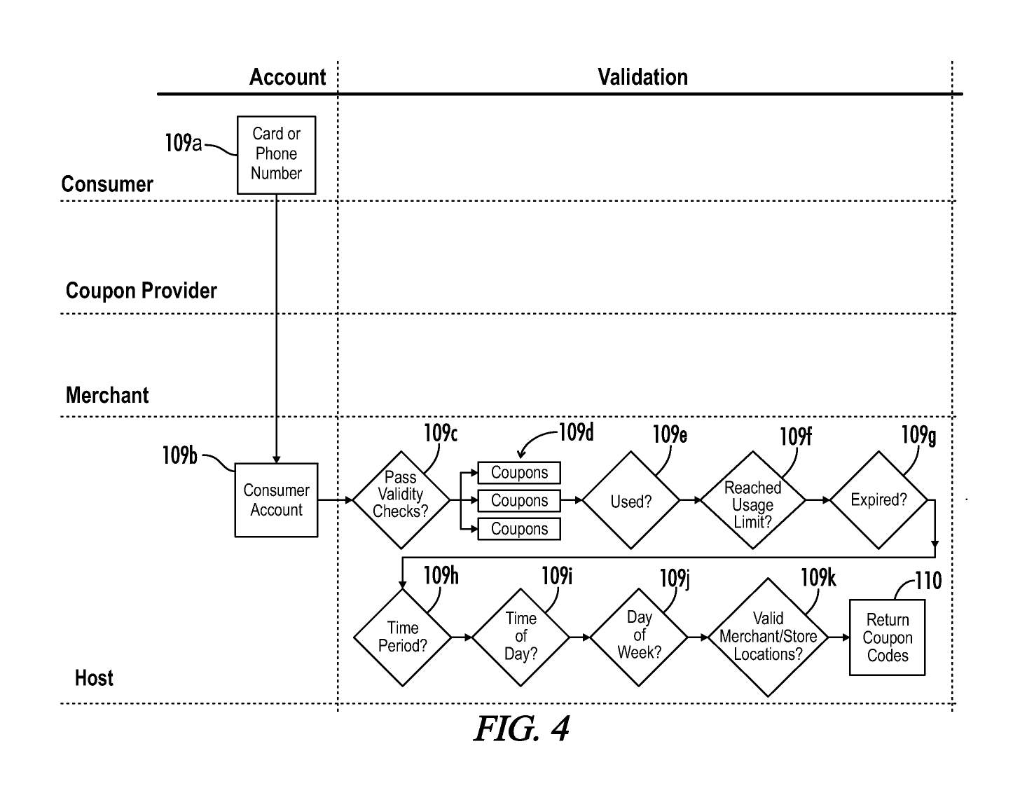

Referring now to FIGS. 2 to 4, methods 100, 200, 300 in accordance with a host system 10 of the present invention may be described in greater detail herein. A first comprehensive method 100 may be described herein with reference to each of FIGS. 2 to 4. A second method 200 being described with reference to FIG. 2 and relating more specifically to the perspective of the host system 10 and a third method 300 being described with reference to FIG. 3 and relating in part to aspects or steps which are not explicitly performed by the host system 10 are included herein within the description of the first method 100 and additional description may be omitted as unnecessary. Various sub-steps as described with reference to FIG. 4 may relate to a step 109 in each of the aforementioned methods 100, 200, 300, although each of the methods 100, 200, 300 may also be performed without each of the sub-steps so described.

The methods described herein are merely intended to illustrate particular embodiments and are not otherwise limiting on the scope of the present invention as may be understood by one of skill in the art. For example, it is anticipated that in various embodiments one or more steps may be omitted from any of the methods 100, 200, 300 as described herein within the scope of the present invention, and one or more additional steps not described herein may likewise be provided by any of the methods 100, 200, 300 without affecting the scope of the present invention.

### Step 101

The host system 10 provides a user interface 20 for receiving and transmitting data within the scope of the present invention, which as described above may be for example a host website having an associated graphical user interface accessible via the Internet. Alternatively or additionally, the host system 10 may in certain embodiments provide a user interface by downloading instructions or data to a mobile computing or mobile communications device such that a graphical user interface 26 may be launched and displayed remotely from the remainder of the host system, or alternatively stated locally with respect to the remote device (e.g., a user system 24).

### Steps 102 and 103

A coupon provider, such as for example a distributor, manufacturer, supplier, wholesaler, retailer, etc., of consumer products for which coupons may desirably be provided to potential consumers, may create one or more electronic coupons and associated electronic coupon parameters (e.g., selection rules).

Alternatively, a coupon provider may be a third party coupon provider that receives electronic coupons from a distributor, manufacturer, supplier, wholesaler, retailer, etc., of associated consumer products (i.e., consumer product provider) and posts the electronic coupons and electronic coupon parameters on a third party website. The coupon parameters may be provided by either or both of the consumer product provider and the coupon provider.

In an embodiment the coupon provider may create the coupons on the coupon provider system 30 (which as described above may be associated with a consumer product provider or a third party coupon provider) and provide data associated with the electronic coupons and parameters to the host system in a predetermined format (step 102 of FIG. 3). The host system may then selectively post the electronic coupons to portions of the website for display or otherwise accessible to potential consumers who are approved to review and select one or more of the coupons (step 103 of FIG. 3). In certain embodiments the host system may post or otherwise submit the coupons to third party websites associated with participating merchants in addition to, or exclusive of, posting the coupons on a host web site itself.

In another embodiment (not shown), the coupon provider may access the website of the host system and create the electronic coupon and associated parameters within the host system using for example predefined templates, pull-down menus, data entry boxes, data associated with the coupon provider and saved from previous sessions, etc.

In yet another embodiment (not shown), the coupon provider may create a portion of the coupons or associated parameters on the coupon provider system, provide associated data to the host system, and then supplement the initial data within the website using features as described above.

In various embodiments coupon providers 30 may also be merchants which create electronic coupons on the merchant point of sale system 28 for themselves or the respective consumer product providers to allow for redemption of coupon codes provided by the host system.

Examples of relevant electronic coupon parameters may include without limitation an approved list or segment of users for whom the coupon is valid, a maximum number of valid uses, a date range in which the coupon is valid, an approved list or segment of merchants, locations, demographics and the like for which the coupon is valid, and any other information necessary for the host system to determine the availability of the electronic coupon for a particular financial transaction.

The host system may in various embodiments further proactively remove coupons from the website which have expired or otherwise been rendered unavailable in accordance with the electronic coupon parameters.

### Step 104

Users may acquire access to electronic coupons via the host website (or in certain embodiments as described above via a merchant websites, consumer product provider websites, or participating third party coupon provider websites). In various embodiments, users may be required by the host system to register with the host system/website or otherwise become a member of a program administered by the host system in order to access the coupons. Alternatively, member registration may provide merely an additional access criterion by which the host system selectively provides access to coupons (in step 105 below).

The user may be prompted to enter certain information to register to the website such as for example one or more of a name, address, email address, various demographic information, personal consumer preferences, etc., and may further be required to provide an identifier by which the host system may identify the user as a member of the system and further associate the member with a member account and any information included therein. The identifier may be information that is capable of being presented at a point of sale during a financial transaction, such as for example a card number, a telephone number, a personal identification number, etc.

### Step 105

Once registered, the member user may access relevant portions of the host website to review one or more electronic coupons that have previously been posted and are available for display. The particular member may be restricted in which coupons are available for displaying based on, for example, access criteria associated with the member user and the electronic coupon parameters provided by the coupon provider. For example, the user may be prompted to enter certain information during member registration which may be used by coupon providers to filter or otherwise target coupons to particular subsets or groups of potential consumers.

In an embodiment, there may be no particular restriction with regards to the electronic coupons that are displayed on a particular webpage, but the host system may highlight one or more coupons that are available for selection by the user, or display available coupons and unavailable coupons in different fonts or other distinctive display formats which make the distinction objectively clear to the viewer. Alternatively, the host system may display only those coupons that are available to the particular user and remove from view any other coupons which are unavailable.

The user may then select one or more electronic coupons for intended later use with financial transactions, by for example selecting the one or more coupons and then clicking a button to submit the coupons to the host system for storage in association with the user account, by clicking and dragging selected coupons, or by other selection methods which are known in the art. Upon selecting and submitting the one or more electronic coupons, electronic coupon selection data associated with the user is thereby transmitted to the host system from the interface.

In certain embodiments, the host system may upload coupon display data to the user for display on a graphical user interface local to the user computer or mobile device. Upon selecting one or more coupons, the user then submits the electronic coupon selection data to the host system via a communications network.

In various embodiments the user may be provided with the ability to print the electronic coupons or a summary of electronic coupons that have been selected, either generally or with regards to a particular merchant or coupon provider. However, the host system may be configured to print a subset of electronic coupon data that is insufficient alone for presentation at a point of sale, thereby rendering the printed electronic coupon to the user only as a visual aid and substantially preventing any fraudulent use of such a coupon during a financial transaction.

### Step 106

The host system then receives the electronic coupon selection data, whether internally submitted via the host website or externally submitted via for example a mobile device or even from a third party website which posts the electronic coupons and through which users may select the coupons as described above, and stores the data in a database or equivalent storage media in association with a user account. In various embodiments the host system may be programmed to periodically search for and remove any electronic coupons which are stored in the user account but are no longer available for use, such as for example due to having expired or otherwise associated with products that are no longer available.

In various embodiments, as may be understood by one of skill in the art, the host system of the present invention precludes the necessity of linking to various external systems such as for example participating loyalty programs to communicate both coupon availability and redemption across multiple merchant platforms. Rather, usage is available at any participating merchant with inefficient or complex cross communication substantially eliminated due to centralized control of the process by the host system.

### Steps 107 and 108

During a financial transaction associated with a participating merchant, the user may provide his or her identifier at the point of sale (step 107a in FIG. 3). The identifier may be for example a card with a magnetic stripe or barcode which can be scanned at the point of sale, a card number which may be keyed in manually at the point of sale, a telephone number which may be keyed in manually, or a telephone having NFC capability for transmitting identifying information. The identifier and associated data such as for example embedded in a magnetic stripe may be used by the host system to identify the user account and confirm the identity of the user. In this manner, electronic coupons residing in the user account may be substantially prevented from being fraudulently reproduced or shared across consumers due to the secure nature of the account number and identification process. Reducing the burden on the user of printing and carrying coupons with them to each merchant and point of sale further provides incentives for consumer participation.

The point of sale terminal (merchant computer 28) then processes the financial transaction in accordance with the standard procedures for the merchant (step 107b) and further transmits transaction data to the host system (step 108) via a communications network along with a request to provide any available coupons for use in the transaction. The transaction data may include for example one or more of the user identifier presented at the point of sale, purchasing information such as one or more products being purchased, amounts of the purchases, time and date of the transaction, location of point of sale, currency code, etc.

### Step 109

Upon receiving the transaction data from the point of sale, the host system may then evaluate the transaction data including the user identifier and determine the availability of any one or more coupons that are stored in the user account for use in the associated financial transaction based on for example the transaction data and the coupon parameters.

If no electronic coupons stored in the user account are determined to be available for a transaction associated with the received financial transaction data (i.e., “no” in response to the query in step 109) the process skips to step 113.

In various embodiments, the host system may be configured to evaluate the transaction data and determine the availability of any one or more coupons that are stored not only in the user account subsequent to actual user selection, but also that may be associated more generally with the merchant, the location, the manufacturer or distributor of the product, or any other coupons that may be stored in other areas of the host system and intended for use by all consumers of the given product in accordance with electronic coupon parameters provided by the coupon provider. These coupons may be applied automatically, or in certain embodiments or within certain contexts the coupons may be provided to the point of sale with a notation that the coupons are available for manual consumer selection if desired but not to be automatically applied to the transaction, such as for example if the consumer would be required to perform some action to redeem the coupon and may otherwise prefer to complete the transaction without the coupon.

In an embodiment as represented in FIG. 4, the step of evaluating transaction data and validating available coupons may include one or more sub-steps of: receiving an identifier from the point of sale in the form of for example a card or telephone number (step 109a); identifying and confirming a user account associated with the consumer presenting the identifier (step 109b); evaluating the various electronic coupons stored in the user account based on the transaction data and coupon parameters (step 109c); identifying any electronic coupons that are available based on the evaluation step (step 109d); determining if any one or more of the identified coupons should be removed or rejected as having been previously used (step 109e); determining if any one or more of the identified coupons should be removed as having reached a predetermined maximum number of uses (step 109f); determining if any one or more of the identified coupons should be removed as having expired in light of the current date and the date range provided with the coupon parameters (step 109g); determining if any one or more of the identified coupons should be removed as being only valid during a time period which has not yet occurred or at least is not consistent with a current time period (step 109h); determining if any one or more of the identified coupons should be removed as being only valid during a time of day which is not consistent with a current time of day (step 109i); determining if any one or more of the identified coupons should be removed as being only valid during a day of the week which is not consistent with a current day of the week (step 109j); determining if any one or more of the identified coupons should be removed as being only valid for a particular merchant or store location which is not consistent with a current merchant or store location, respectively (step 109k).

### Step 110

If one or more electronic coupons stored in the user account are determined to be available for a transaction associated with the received financial transaction data (i.e., “yes” in response to the query in step 109) the host system identifies the electronic coupons and submits available electronic coupon data to the point of sale sufficient for the point of sale terminal (or associated merchant systems functionally linked to the point of sale terminal) to identify the available electronic coupons and associated discounts. For example, the host system may provide available electronic coupon data such as a promotional code that simply identifies existing data in the merchant system wherein the merchant pulls up the coupon and applies it using internal mechanisms, or alternatively the host system may provide an amount of the electronic coupon and an identifier that the merchant may use at the point of sale to internally look up and confirm the existence of the coupon and whether the discount is appropriate.

### Step 111

Upon receiving the available electronic coupon data from the host system, the merchant may identify and isolate products associated with each electronic coupon within their point of sale (step 111a in FIG. 3). In various embodiments and depending on the internal system used by the merchant, the merchant may perform a coupon lookup or search process to determine the applicable coupon rules and then apply the rules to the appropriate coupons (step 111b in FIG. 3). In various embodiments the host system may therefore be configured to generate and provide available electronic coupon data to a particular merchant in a format that is already resident within the existing coupon process of the merchant system.

### Step 112

The merchant (point of sale) upon determining which coupons are to be utilized or redeemed in association with the financial transaction may then transmit redeemed electronic coupon data to the host system. The host system receives the redeemed electronic coupon data from the point of sale and is capable of identifying the particular electronic coupons which have been utilized or redeemed from the received data.

In various embodiments this step may take place immediately after or simultaneous with the processing of the financial transaction at the point of sale, or alternatively redeemed electronic coupon data may be submitted by the point of sale to the host system at periodic intervals or otherwise at some time after the completion of the financial transaction.

### Step 113

The merchant (point of sale) in accordance with the present invention may then proceed with the financial transaction in substantially the same manner as with other transactions, including collecting additional tender from the consumer above any discount applied in association with the redeemed electronic coupons (step 113a in FIG. 3), completing the financial transaction within the scope of the internal mechanisms or processes associated with the point of sale (step 113b) and providing the purchased items and receipt where applicable to the consumer (step 113c). One distinction of note however is that within the scope of the present invention the point of sale proceeds with the financial transaction without being required to manually handle paper coupons and confirm information associated with the consumer, the purchased products, coupon rules, or any other confirmation steps which would otherwise be necessary to prevent or substantially reduce fraudulent activity.

### Step 114

The host system may, upon receiving the redeemed electronic coupon data from the point of sale, then determined the continued availability or lack thereof with respect to the electronic coupons that have been redeemed in the financial transaction. For example, where electronic coupon parameters include a limited number of uses for the electronic coupon generally, or more particularly with respect to a particular user or product, the host system may identify such electronic coupons after redemption and remove them from the user account so that they may not be applied or otherwise reused in subsequent financial transactions.

In various embodiments the user may be able to reenter the system and select the electronic coupons again for use in subsequent transactions, depending on the predetermined electronic coupon parameters. The host system may however be configured to track electronic coupon usage and limit a particular user to a predetermined number of electronic coupon selections or otherwise flag a particular user or electronic coupon for reporting to the coupon provider or merchant as appropriate.

In various embodiments where the host system works in accordance with or otherwise alongside a third party such as a coupon provider or the equivalent, the host system may upon evaluating a financial transaction and determining the continued availability of redeemed coupons further provide information to the third party system. This information may be used by the third party to for example evaluate and remove coupons which may be posted on a third party website, or simply to update records or track consumer activity, etc. The information may in various embodiments be provided in accordance with independent transactions or periodically as a report including one or more transactions within a predetermined time period.

### Steps 115 and 116

The host system may further provide or facilitate the reporting and reconciliation processes with respect to the merchant and coupon provider as applicable (step 115). Reports may be generated for each financial transaction or may alternatively be compiled over predetermined intervals with respect to one or more financial transactions involving a particular merchant and electronic coupons provided by a particular coupon provider. The reports and reconciliation procedures carried out by the host system may be configured in accordance with internal requirements of the particular merchant and coupon provider, and in various embodiments the host system may electronically reconcile and transfer funds directly from an account associated with the coupon provider to an account associated with the merchant.

In various embodiments the host system may alternatively merely provide reporting and reconciliation data in a predetermined format to either or both of the merchant and the coupon provider wherein the individual parties may electronically complete the reconciliation and settlement process between themselves (steps 116a and 116b) and potentially without requiring a manual transfer or collection of paper between parties.

The previous detailed description has been provided for the purposes of illustration and description. Thus, although there have been described particular embodiments of the present invention of a new and useful “System and Method of Redeeming Coupons and Preventing Web-Based Coupon Fraud,” it is not intended that such references be construed as limitations upon the scope of this invention except as set forth in the following claims.

What is claimed is:

1. A system comprising:
one or more processors;
one or more computer-readable memory media storing having instructions residing thereon, the instructions executable by the one or more processors to cause the processors to perform operations comprising:
generating a web-based user interface associated with a host website;
receiving electronic coupon parameters associated with one or more electronic coupons from a coupon provider via the web-based user interface;
receiving transaction data associated with a financial transaction from a point of sale associated with a merchant;
determining the availability of one or more electronic coupons for use in the transaction based on the coupon parameters and the transaction data;
providing a first set of electronic coupon data to the point of sale, the electronic coupon data associated with one or more electronic coupons which have been determined to be available; and
receiving a second set of electronic coupon data from the point of sale, the electronic coupon data associated with one or more electronic coupons which have been redeemed by the merchant in association with the financial transaction.

2. The system of claim 1, the instructions further executable by the one or more processors to cause the processors to perform operations comprising:
selectively providing access to one or more electronic coupons by a user of the host website based on the electronic coupon parameters and access criteria associated with the user; and
receiving electronic coupon selection data from the user via the user interface and storing electronic coupons associated with the selection data in a user account.

3. The system of claim 2, the instructions further executable by the one or more processors to cause the processors to selectively provide access to the one or more electronic coupons by users that are members of the host website.

4. The system of claim 2, the availability of one or more electronic coupons for use in the transaction determined based on the coupon parameters for the electronic coupons stored in the user account and the transaction data.

5. The system of claim 2, the availability of one or more electronic coupons for use in the transaction determined based on the coupon parameters for the electronic coupons stored in the user account, the coupon parameters for one or more general use electronic coupons associated with the merchant and the transaction data.

6. The system of claim 2, the transaction data comprising a consumer identifier, wherein determining the availability of one or more electronic coupons for use in the transaction is based in part on a comparison between the consumer identifier and a user identifier stored in the user account.

7. The system of claim 1, the instructions further executable by the one or more processors to cause the processors to perform an operation comprising:
removing access to one or more electronic coupons via the user interface which have expired based on a predetermined range of dates in the coupon parameters.

8. The system of claim 1, the instructions further executable by the one or more processors to cause the processors to perform an operation comprising:
removing access to one or more electronic coupons via the user interface which have been used a number of times greater than a predetermined maximum number of user in the coupon parameters.

9. The system of claim 1, the instructions further executable by the one or more processors to cause the processors to perform an operation comprising:
automatically electronically reconciling accounts associated with the coupon provider and the merchant based on the redeemed electronic coupons and transferring funds between said accounts in accordance with the reconciliation.

10. The system of claim 1, the instructions further executable by the one or more processors to cause the processors to perform an operation comprising:
determining whether to remove access to the one or more redeemed electronic coupons or to continue to provide access to the one or more redeemed electronic coupons based on the associated coupon parameters.

11. A method comprising:
generating via one or more processors a web-based user interface associated with a host website;
receiving electronic coupon parameters associated with one or more electronic coupons from a coupon provider via the web-based user interface;
receiving transaction data associated with a financial transaction from a point of sale associated with a merchant;
determining the availability of one or more electronic coupons for use in the transaction based on the coupon parameters and the transaction data;
providing a first set of electronic coupon data to the point of sale, the electronic coupon data associated with one or more electronic coupons which have been determined to be available; and
receiving a second set of electronic coupon data from the point of sale, the electronic coupon data associated with one or more electronic coupons which have been redeemed by the merchant in association with the financial transaction.

12. The method of claim 11, further comprising:
selectively providing access to one or more electronic coupons by a user of the host website based on the electronic coupon parameters and access criteria associated with the user; and
receiving electronic coupon selection data from the user via the user interface and storing electronic coupons associated with the selection data in a user account.

13. The method of claim 12, further comprising selectively providing access to the one or more electronic coupons by users that are members of the host website.

14. The method of claim 12, wherein determining the availability of one or more electronic coupons for use in the transaction is based on the coupon parameters for the electronic coupons stored in the user account and the transaction data.

15. The method of claim 12, wherein determining the availability of one or more electronic coupons for use in the transaction is based on the coupon parameters for the electronic coupons stored in the user account, the coupon parameters for one or more general use electronic coupons associated with the merchant and the transaction data.

16. The method of claim 12, the transaction data comprising a consumer identifier, wherein determining the availability of one or more electronic coupons for use in the transaction is based in part on a comparison between the consumer identifier and a user identifier stored in the user account.

17. The method of claim 11, further comprising:
removing access to one or more electronic coupons via the user interface which have expired based on a predetermined range of dates in the coupon parameters.

18. The method of claim 11, further comprising:
removing access to one or more electronic coupons via the user interface which have been used a number of times greater than a predetermined maximum number of user in the coupon parameters.

19. The method of claim 11, further comprising:
determining whether to remove access to the one or more redeemed electronic coupons or to continue to provide access to the one or more redeemed electronic coupons based on the associated coupon parameters.

20. One or more computer-readable memory media storing having instructions residing thereon, the instructions executable by a processor functionally linked to a host website to cause the processor to perform operations comprising:
receiving electronic coupon parameters associated with one or more electronic coupons from a coupon provider via the host website;
selectively providing access to one or more electronic coupons by a user of the host website based on the electronic coupon parameters and access criteria associated with the user;
receiving electronic coupon selection data from the user via the user interface and storing electronic coupons associated with the selection data in a user account;
receiving transaction data associated with a financial transaction from a point of sale associated with a merchant;
determining the availability of one or more electronic coupons for use in the transaction based on the coupon parameters and the transaction data;
providing a first set of electronic coupon data to the point of sale, the electronic coupon data associated with one or more electronic coupons which have been determined to be available; and
receiving a second set of electronic coupon data from the point of sale, the electronic coupon data associated with one or more electronic coupons which have been redeemed by the merchant in association with the financial transaction.
